(19) United States
(12) Patent Application Publication
(10) Pub. No.: US 2016/0156958 A1
(43) Pub. Date: Jun. 2, 2016

(54) RECORDING AND TIME-DELAYED PLAYBACK OF MEDIA ITEMS

(71) Applicant: Deutsche Telekom AG, Bonn (DE)

(72) Inventors: Fred RUNGE, Wuensdorf (DE); Michael Kern, Berlin (DE)

(21) Appl. No.: 14/953,047

(22) Filed: Nov. 27, 2015

(30) Foreign Application Priority Data
Nov. 29, 2014 (DE) 10 2014 117 567.0

(51) Int. Cl. H04N 21/433; H04N 21/472; G11B 27/10; H04N 21/462

(52) U.S. Cl. CPC H04N 21/4334; H04N 21/4332; H04N 21/4622; H04N 21/47217; G11B 27/102

(57) ABSTRACT

A method for recording of media items broadcast from at least one channel source and for time-delayed playback of a media item recorded in a memory region reserved for time-delayed playback and received by a terminal arrangement configured for time-delayed playback includes: recording a schedule broadcast by the at least one channel source as a media data stream; and playing back a media item already running at the point in time at which the at least one channel source is selected, irrespective of the point in time of the selection, from the start of the item, or from an earliest point in time available in the reserved memory region.

### CROSS-REFERENCE TO RELATED APPLICATIONS

Priority is claimed to German Patent Application No. DE 10 2014 117 567.0, filed on Nov. 29, 2014.

### FIELD

The invention relates to recording and time-delayed playback of media items which are provided by corresponding content providers terrestrially, by satellite or over a network, for example as a live stream over the Internet, and broadcast by a channel source. In this connection, the media items may be audio items, such as pieces of music, concert recordings or radio drama items, and also video items, such as films, magazine programmes, entertainment programmes and the like. Embodiments of the invention for the recording and time-delayed playback of these items relates to a method and to a system suitable for carrying out said method. It further relates to a terminal for local recording and time-delayed playback of media items.

### BACKGROUND

Solutions for recording media content or items for the purposes of time-delayed playback thereof, which are also available to a private user, have long been known. Here, the progression of such solutions, or in some cases also the development thereof in parallel, led for example from the cassette recorder, for recording music and speech, through the video recorder, for recording films and other video items, to the hard disk drive recorder, with which media content can be recorded on a hard drive (HDD) or more recently also in a semiconductor memory in the form of an SSD (solid state disk).

In particular in connection with the development of this last category of devices, solutions have also become known which make it possible for the user, such as the private or home user, to record a media item broadcast by a broadcaster and to play said media item back in a time-delayed manner while recording thereof continues. Solutions of this type for the time-delayed playback of media items have come to be known by the term time-shift.

Terminals which provide a time-shift function of this type make it possible for the user, while consuming a media item broadcast by a broadcaster, for example while watching a video item, to press a button often referred to or represented as a pause button, and thus, apparently, to interrupt the running schedule or the playback of the item for a relatively long time. However, starting from the time at which the aforementioned pause button is pressed, the media item being played back is, in fact, being recorded on a suitable storage medium (for example on a hard drive) in the terminal providing the time-shift function, and can be played back, at a later time, from the time of the apparent interruption by pressing the aforementioned button again or by pressing another button which cancels the pause function. It is further possible for the user to move forwards and backwards as desired within the already recorded sequence of the item or to interrupt the playback again, provided that these functions are not blocked by the content provider, in particular for the purpose of capitalising on advertising.

While terminals operating in the above-described manner still require a special button (pause button or the like) to be pressed in order to initiate the recording of an item which is running, in the meantime device designs have become known in which this is not necessary. In end devices of this type, the recording of a running item is instead initiated by different operating actions, brought about by the user independently of an intention to record an item. In this case, the recording of a media item, that is to say the recording of a currently running schedule, is started in particular at the point in time at which the device is switched on and at the point in time at which this causes the current schedule of the broadcaster most recently used by the device (or the last channel source used) to be output, or as a result of switching from one broadcaster/channel source to another. Thus, without the user having to do this deliberately, switching on the terminal or switching over the broadcaster starts the recording of the respective running schedule of the currently selected broadcaster, and makes it possible for the user to play back the item in question in a time-delayed manner by moving within the already recorded sequence of this schedule, likewise by actuating corresponding operating elements. In this case too, the schedule in question continues to be recorded in the meantime during the time-delayed playback of an item.

The maximum possible time delay between the schedule currently being broadcast and the recorded schedule portions is determined by the size of the memory provided by the device for this type of recording. Of course, because of the necessity for a memory of this type always to be of a finite size, there is always a limitation in this respect. However, irrespective of this insurmountable circumstance, the aforementioned solutions are disadvantageous in that a media item broadcast by a channel source/broadcaster as part of a schedule can be played back in a time-delayed manner only starting at time at which the channel source in question was selected to play back the schedule thereof. Time-delayed playback of portions, which are even further in the past, of a media item already running when a channel source is selected is thus not possible.

### SUMMARY

In an embodiment, the invention provides a method for recording of media items broadcast from at least one channel source and for time-delayed playback of a media item recorded in a memory region reserved for time-delayed playback and received by a terminal arrangement configured for time-delayed playback. The method includes: recording a schedule broadcast by the at least one channel source as a media data stream, irrespective of whether the at least one channel source is currently selected for playback of the schedule broadcast thereby and independently of further operating actions by a user of the terminal arrangement, wherein the recording comprises: storing in the memory region reserved for time-delayed playback, wherein the memory is organized as a first-in first-out (FIFO) memory, permanently or starting at the point in time at which the terminal arrangement is switched on; and playing back a media item already running at the point in time at which the at least one channel source is selected, irrespective of the point in time of the selection, from the start of the item, or from an earliest point in time available in the reserved memory region.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a possible embodiment of the system having local storage of the schedule from a channel source,

FIG. 2 shows a first, network-based embodiment of the system,

FIG. 3 shows an embodiment, forming an alternative to FIG. 2, of a network-based system, and

FIG. 4 shows a further possible embodiment of a network-based system.

### DETAILED DESCRIPTION

Embodiments of the invention overcome the aforementioned disadvantages and provide for the recording and time-delayed playback of media items in a more convenient manner. For this purpose, a method and a system suitable for carrying out said method are provided. Furthermore, the invention provides a terminal arrangement suitable for carrying out the method, in which corresponding media items are recorded locally in this terminal.

In an exemplary embodiment, the invention provides a method for the recording of media items broadcast by at least one channel source and for the time-delayed playback of an item of this type, which is recorded in a memory region reserved therefor and received by a terminal arrangement designed for this purpose. An item of this type is thus a portion of the schedule broadcast by the channel source in question in the form of a media data stream, in other words a data stream including media data.

The method is configured in such a way that an item, which is broadcast by the aforementioned at least one channel source and which is already running at the point in time at which this channel source is selected for playback of the schedule thereof, is provided by the terminal arrangement for time-delayed playback starting from the item start detected during the schedule recording, or at least from the earliest point in time available in the memory region reserved for the schedule recording, which is in any case irrespective of the point in time at which the channel source in question is selected. The method is configured such that playback of an item of this type, which is already running when the corresponding channel source is selected, is made possible preferably from the start of the item in question, the item thus being provided for playback from the start thereof. “Provided” means that the basic option is provided of playing back an item from the start or from an earliest available point in time, although of course there must be an operating action by the user of the terminal device to trigger playback of this type. By contrast, the schedule or media item from the at least one channel source is recorded automatically independently of any (further) operating action by the user.

The stated limitation, whereby in exceptional cases the playback of the item is not provided from the start thereof but instead from a different point in time which is the earliest available in the reserved memory region, has several reasons behind it, which will be explained later, at least in part, only in connection with the description of different embodiments of the invention. At this point, it should merely be noted that the size of a memory region reserved for storing a media data stream representing a schedule is of course finite, in other words limited. A memory region of this type is preferably organised as a FIFO (first in, first out) memory. If it is organised as a FIFO memory, the memory region in question should be understood as a ring memory or ring buffer in logical terms. Thus, if the (logical) end of the reserved memory region is reached during the process of recording a schedule, the recording is continued at the start of the memory region, and scheduled content or portions of the media data stream previously stored there are overwritten again.

Because of this finite size of the memory region reserved for the recording, when a very long media item is recorded, the portions recorded first, including the start of the item, may be overwritten again. In this case, it is of course no longer possible to play back the item from the start thereof. Nevertheless, in exemplary embodiments of the invention, it is still possible to play back, in a time-delayed manner, portions of the item which have already been broadcast by a, or the at least one, channel source, when this channel source was not yet currently selected by the user for the playback of the schedules broadcast thereby, in other words before the user had switched for example to a terrestrial broadcaster as the channel source broadcasting the item. However, apart from the possible exception described above, exemplary embodiments of the invention are configured to make possible time-delayed playback of an item from the start thereof.

The at least one channel source may for example be devices of a broadcaster broadcasting terrestrially transmitted scheduled content, a radio broadcaster, or may be a streaming service which distributes scheduled content over a network, such as the Internet. Of course, the invention also includes other channel sources and transmission methods using different transmission media, such as satellite transmission or cable television, and the like.

When reference is made to the recording of the schedule or the time-delayed playback of media items from at least one channel source, this emphasises the fact that the method according to the invention, but in particular the system to be described in the following, makes it possible to preferably record and play back in a time-delayed manner media items from a plurality of channel sources. In this context, the schedules from a plurality of channel sources are recorded in parallel, and thus in effect in the background, as the recording takes place irrespective of whether a channel source is currently selected for the playback of the schedule broadcast thereby, and, provided a channel source is selected, irrespective of which channel source this is. For each channel source, of which the schedule is being recorded, a corresponding memory region reserved for the recording is provided.

Depending on the specific configuration of the system, the schedule of the at least one channel source may be recorded either locally, in other words in a reserved memory region which is formed as part of the terminal arrangement of the user, which is to be disclosed in greater detail in the following, or in a reserved memory region in the technical devices of a schedule provider or a provider of a corresponding service. In the latter case, where the reserved memory region is arranged non-locally, the terminal arrangement has access to corresponding devices, a component of which is a reserved memory region of this type, over a network, preferably over the Internet. These corresponding devices are addressed by the terminal arrangement over the network for time-delayed playback of a recorded media item, and may be configured further, for example to establish for which channel sources the schedule is to be recorded.

In particular in the case where the schedules of a plurality of channel sources are recorded locally, the number thereof will preferably be limited in view of the aforementioned finite nature of the available memory. Corresponding channel sources may preferably be set by the user as favourites in a configuration process via the terminal arrangement. Of course, in a further configuration process, these favourites may optionally be replaced with others. In this context, a memory region which was reserved for recording the schedule of a channel source subsequently no longer included in the favourites, and which has already been written with schedule content from the channel source in question, is simply overwritten with the schedule of a different channel source which is added to the favourites instead. For the purpose of reducing the memory requirement required for recording the schedules of a plurality of channel sources, in a development of the method it may be provided that the file format of the data stream representing the schedule of a respective channel source is recoded or converted, during recording, into a different file format which requires less memory to record, or that the data stream to be recorded is compressed during recording.

According to the understanding which is taken as a basis in this case, the playback of a schedule currently being recorded or the time-delayed playback of media items may take place using an individual terminal (for example a television having a receiving component or having at least one receiver and optionally having a component for recording received media streams, such as its own hard disk) or else using a plurality of interacting appliances (for example a television coupled to a hard disk drive), depending on the configuration of the technology, which is available for this purpose, at the receiving end. For this reason, reference is made to a terminal arrangement in relation to the technology at the receiving end.

In accordance with the method according to the invention, the schedule broadcast by the at least one channel source is recorded by storing the media data stream representing this schedule in the aforementioned reserved memory region, irrespective of whether and when the channel source in question is selected for the playback of the schedule broadcast thereby. In this context, the schedule is recorded in the memory region reserved therefor either permanently or starting at the point in time at which the aforementioned terminal arrangement is switched on.

Which of the two aforementioned alternatives is implemented when the invention is used depends, as will be shown in the following, in particular on where the schedule is recorded or where the reserved memory region provided therefor is arranged. In particular, if this memory region is arranged locally, in other words as a component of the terminal arrangement, the schedule of the at least one channel source may be (but does not have to be) recorded only starting at the time at which at least this terminal arrangement is switched on. In this context, the point in time at which the terminal arrangement is switched on should be understood to mean the point in time at which the terminal arrangement changes from being in a standby state or from being in an off state (in which the terminal arrangement or the terminal or terminals associated therewith are powered down) into an operating state, in which it is possible to play back media items, as a result of a corresponding operating action by a user. However, with regard to the aforementioned hard disk drive, this does not mean that in an operating state of this type the or a channel source broadcasting scheduled content (comprising one or more media items which may optionally be played back only subsequently in a time-delayed manner) is selected immediately for playback in the switched-on state. Instead, the user of the terminal arrangement may perhaps have switched this on so as—completely without regard for the currently running schedules—to play back scheduled content which was recorded previously much earlier. Irrespective of this, however, the recording of the schedule of a plurality of channel sources, for example set as favourites in a configuration process, but at least one channel source, in a memory region reserved for the respective channel source, starts as early as this point in time, in other words at the point in time at which the terminal arrangement is switched on.

As a result, provided the user subsequently selects this/these channel source(s) (or one of them) for playback of the current schedule, that is to say, for example, switches a receiving appliance to a terrestrially transmitting broadcaster, he has the option, via a further operating action, of playing back a media item broadcast by this channel source and already running at the point in time of selection thereof from the start or equally from the aforementioned earlier point in time available in the reserved memory region. It should again be emphasised that this later point in time, which may not be identical to the start of the item, is, in any case, irrespective of the time at which the channel source broadcasting this item is selected or irrespective of the point in time of switching to the broadcaster broadcasting the item.

However, even in the case where the reserved memory region is arranged locally, in other words provided as a component of the terminal arrangement, it is possible to record the schedule and thus to record broadcast media items from the at least one channel source even before the terminal arrangement is switched on. Specifically, this is the case if the terminal arrangement is switched on (in other words changes to being in an operating state) from a standby state or from standby operation, and recording still takes place in standby operation of the terminal arrangement, as may be provided according to a possible embodiment of the invention. The only prerequisite for this is that particular components and/or appliances of the terminal arrangement which are required for the recording and for controlling said recording still receive power in standby operation

To implement the above-disclosed method in practice, during the recording of the schedule of the at least one channel source, which as explained above takes place in effect in the background, that is to say in any case irrespective of whether this channel source is currently selected for playback of the schedule thereof, the address, which is currently being written in each case with the media data stream of the recorded schedule, of the reserved memory region is noted as the current write address in a pointer memory.

Accordingly, it is further provided that during the schedule recording, to detect a start of an item, features indicating the start of an item are evaluated. Various exemplary implementations of the invention are possible in view of the type of aforementioned features. This may be additional information (for example RDS or videotext) which is added to the schedule at the transmission end or at the channel source to mark a start of an item. However, it is also conceivable for the terminal arrangement to have components which are “smart” in the sense that they automatically detect the start of media content, in effect in a self-learning manner, by the received sequences of the media data stream being processed using a special software. In this regard, it should be noted that appliances which relatively reliably detect advertising breaks in a schedule are already commercially available.

According to one exemplary embodiment, the method according to the invention is further developed in that, in the case where a start of an item is detected when the schedule of the at least one channel source is being recorded, the current write address, in other words the address of the reserved memory currently being written with the recorded media data stream, is copied to a special address memory. According to an alternatively provided method configuration, if a start of an item is detected, a corresponding start marker is stored, together with the recorded scheduled content, in the reserved memory region, more precisely at the address following the write address currently noted in the pointer memory, in other words before the schedule sequence following the start of the item.

In the first case, that is to say when the start address of a media item is stored in an address memory, an address noted in this address memory at a start of an item is, in any case, removed therefrom again provided the current write address of the recording process, which continues in the meantime in any case, matches the memory address noted as the start address again, as a result of the property of the reserved memory region being in the form of a FIFO memory or circular buffer. This corresponds to the case where a recorded item is very long, and so the start of the item is overwritten again during the recording process in the reserved memory region, and thus is no longer available therefrom for time-delayed playback from the reserved memory region.

The case is similar for the alternative method configuration, according to which the start address is not noted in an address memory, but instead a start marker is stored within the recorded media data stream in the reserved memory region for recording the schedule. In this context, this start marker is overwritten with data from the recorded media data stream provided the recording is still continuing when the reserved memory region has already been completely written, without the sequences representing the start of the item in the recorded media data stream having been read out from this memory region again in the meantime for time-delayed playback of the item.

Depending on whether, as discussed above, the address of a start of an item has been noted in an address memory provided for this purpose or a corresponding marker has been noted, together with the recorded media data stream of a schedule, in the reserved memory region when a start of an item is detected, the rest of the method sequence is subsequently configured as follows. After an operating action provided for this purpose is carried out at the terminal arrangement by a user, the terminal arrangement plays back an item broadcast by the channel source selected at this point in time, in the first case from the address noted in the address memory for the start of the item, or, according to the second alternative, from the memory address following the memory address comprising the marker (most recently) stored for a start of an item.

Provided an address for a start of an item is not or is no longer noted in the address memory provided for this purpose, or, in the case of the alternatively provided recording of corresponding markers together with the media stream, if markers of this type are not present in the reserved memory region and therefore cannot be detected by a corresponding component, the recorded schedule is played back from the address of the reserved memory region which is written in the current recording process and which follows the current write address noted in the pointer memory. If an address for a start of an item has not yet been noted or a start marker has not yet been stored, because no (new) items have started yet since the start of the recording, the aforementioned address is the address of the start of the recording (not the start of the item), at least provided the recording has not yet lasted long enough for the entire reserved memory region to have already been written during the (current) recording. Content already recorded previously, in the portion of the reserved memory region which is free of the current recording, is not taken into consideration.

Irrespective of the selection of an item for time-delayed playback, and irrespective of the manner in which a start of an item is noted (as an address in the address memory or as a marker together with the media data stream in the reserved memory region), the recording process, in other words the recording of the schedule broadcast by the currently selected channel source, still continues even after the user requests an item for time-delayed playback. This applies even if the time-delayed playback is interrupted or the selection of the channel source is cancelled again, for example by selecting a different channel source which may be present to play back the schedule currently being broadcast thereby.

For practical reasons, the method may be configured in such a way that in the reserved memory region, organised as a FIFO memory, in other words as a ring buffer, at most two items are also managed by a combination of a control device and software, which combination controls the schedule recording and time-delayed playback of items, in such a way that an item is still available for a defined delay time after the start of the following item.

In a development of the method according to the invention, it may further also be configured in such a way that it is possible for a user of the terminal arrangement, when selecting a channel source, not only to play back in a time-delayed manner a media item which may currently be running, but to play back a plurality of items already recorded previously in the reserved memory region. In the variant in which, for a detected start of an item, the write address, currently held in the pointer memory, of the recording process is noted in an address memory, the aforementioned address memory is accordingly configured to receive a plurality of memory addresses, each pointing to a start of an item within the reserved memory region for schedule recording. In this case, the address memory is also organised as a FIFO memory.

The selection of an item from a plurality of recorded items for time-delayed playback can be made possible using special, menu-based operating actions in each case or by repeatedly carrying out the operating action discussed previously in connection with the time-delayed playback of the item currently running.

Furthermore, in a development of the method, it may be provided that, via additional operating elements or operating actions, it is made possible for the user of the terminal arrangement to archive items of the running schedule, or items being played back in a time-delayed manner, in an additional memory provided for this purpose, for subsequent further playback.

In addition, at this point it should be noted that it may also be provided for both the start of media items and the end thereof to be detected and accordingly for a start and an end address to be noted in the address memory for a respective item or for a start and end marker to be noted within the recorded media data stream in the reserved memory region. The component for detecting a start of an item is therefore a component for start and end detection. An approach of this type may be expedient for example if strict differentiation between actual items and, for example, advertising blocks is to be possible in the recorded media data stream.

The operating action, discussed repeatedly above, by which a user of the terminal arrangement brings about the time-delayed playback of an item stored as a component of the recorded schedule may be very different depending on the design of the terminal arrangement or of the individual appliances of this arrangement. For example, time-delayed playback of a media item may be provided by pressing a particular key or key combination on a remote control for the terminal arrangement or one of the appliances of this arrangement, by using appropriate speech commands, or by using an icon displayed on a screen by a mouse click or by touching a display, which in this case is touch-sensitive, of the terminal arrangement. Furthermore, a gesture control system may be provided by detecting movements of the user using at least one camera or an acceleration or movement sensor arranged in a remote control or in a smartphone used as a remote control.

In an exemplary embodiment, the invention provides a system, which is suitable for carrying out the above-described method, for the recording and time-delayed playback of media items. The system includes at least one channel source for broadcasting a schedule comprising media items, a component for recording the schedule broadcast by the at least one channel source, and a terminal arrangement, which comprises operating elements, a component for receiving the media data stream broadcast by the at least one channel source and a component for immediate or time-delayed acoustic and/or visual playback of media items contained in this media data stream.

Corresponding to an above-described practical configuration of the method, the system in question further comprises at least storage media comprising a reserved memory region for a recording, which is independent of operating actions of a user of the terminal arrangement and of the channel source currently selected for schedule playback, at least in the switched-on state or in the standby state of the terminal arrangement, of the schedule broadcast by the at least one channel source mentioned at the outset. The system further comprises a pointer memory for storing the address, currently being written with the media data stream in each case, of the aforementioned reserved memory region, a component for detecting the start of a media item (and optionally also for detecting an end of an item), and an address memory for storing at least one memory address (of a memory location written at the start of an item) of the memory region reserved for the schedule recording. In this context, the component for detecting a start of an item is in the form of a control device and software (program application) processed thereby, by which the interaction of the aforementioned component and memories of the system is also controlled.

As stated previously in relation to the method, the memory region reserved for recording the schedule of the at least one channel source is organised as a FIFO memory. The pointer memory may be part of the operating memory or a register of the system according to the invention or a register of the CPU of the control device thereof. The component for detecting the start of a media item, by evaluating features characterising an item start of this type within the recorded schedule, is formed by a combination of software and hardware, as stated previously. To detect the start of individual items, a program routine, processed by the control device of the system as part of the aforementioned software, processes for example information which is additionally broadcast by the channel source broadcasting the recorded schedule. However, it is also conceivable for the control device to process software which detects the start of individual items itself by evaluating the sequences of the recorded schedule.

The system as characterised above is formed in such a way that, for each channel source of which the schedule is recorded for optional time-delayed playback of the media items broadcast thereby, a corresponding memory region is reserved. Of course, this does not mean that each channel source of this type has to be provided with its own storage medium. Rather, on a storage medium, a plurality of mutually independently addressable or handled memory regions may be reserved for recording the respective schedules of different channel sources and be organised as FIFO memories. Ultimately, this is merely a question of logical memory organisation. Depending on the total memory available for schedule recording and the number of available channel sources, it may optionally be made possible to record the schedule of all receivable channel sources. However, in view of the potentially limited memory space or to limit the required memory space, and in view of the large number of available broadcasters or channel sources, embodiments of the invention will preferably be configured in such a way that merely recording of the schedule and time-delayed playback of items contained therein are made possible for channel sources which are to be set as favourites by the user.

The recording of the schedule of one or more channel sources and the associated detection of the start of individual media items may take place locally, in other words within the terminal arrangement, or via corresponding, network-based devices, depending on the specific configuration of the method according to the invention. Accordingly, the storage media comprising the memory region reserved for the schedule recording, the pointer memory for storing the current write address, the address memory for storing the at least one memory address of a start of an item, and the control device comprising the software for detecting a start of a media item and for controlling the interaction of the remaining components or the access to the individual memories and memory regions are either formed locally, as components of the terminal arrangement, or as part of devices arranged within a network.

In the latter case, the corresponding memories and components for carrying out the method may be formed as components of devices of a broadcaster acting as a channel source. However, it is also further conceivable for the corresponding memories and the components for detecting items to be formed as components of devices of a service provider which records the schedules of a plurality of channel sources and provides media items contained therein for time-delayed playback. In this case, the individual memories (memory region reserved for recording, pointer memory and address memory) are each provided once (in other words once each at least in terms of the logical memory organisation) for each channel source supported by the service provider. In any case, however, according to the latter two variants of the system, the terminal arrangement also has its own control device, which interprets the operating actions of a user of the terminal arrangement and triggers the terminal arrangement or appliances or elements thereof to carry out the functions called by the operating action. For time-delayed playback of a recorded item, which takes place as a result of the evaluation of a corresponding operating action by a user, the aforementioned control device of the terminal arrangement interacts with the control device of the broadcaster or of the service provider providing the recording and time-delayed playback of the schedules of a plurality of channel sources.

Irrespective of whether components or memories (reserved memory region, pointer memory and address memory) and the components for controlling access to these memories are arranged locally, in other words as components of the terminal arrangement, or provided in a network-based manner, in other words as components of the devices of a broadcaster (channel source) or service provider, the system may also be supplemented with a further, additional memory, in which items of the running schedule or items of a channel source which are being played back in a time-delayed manner can be archived.

In the following, embodiments of the invention are set out and described with reference to the drawings.

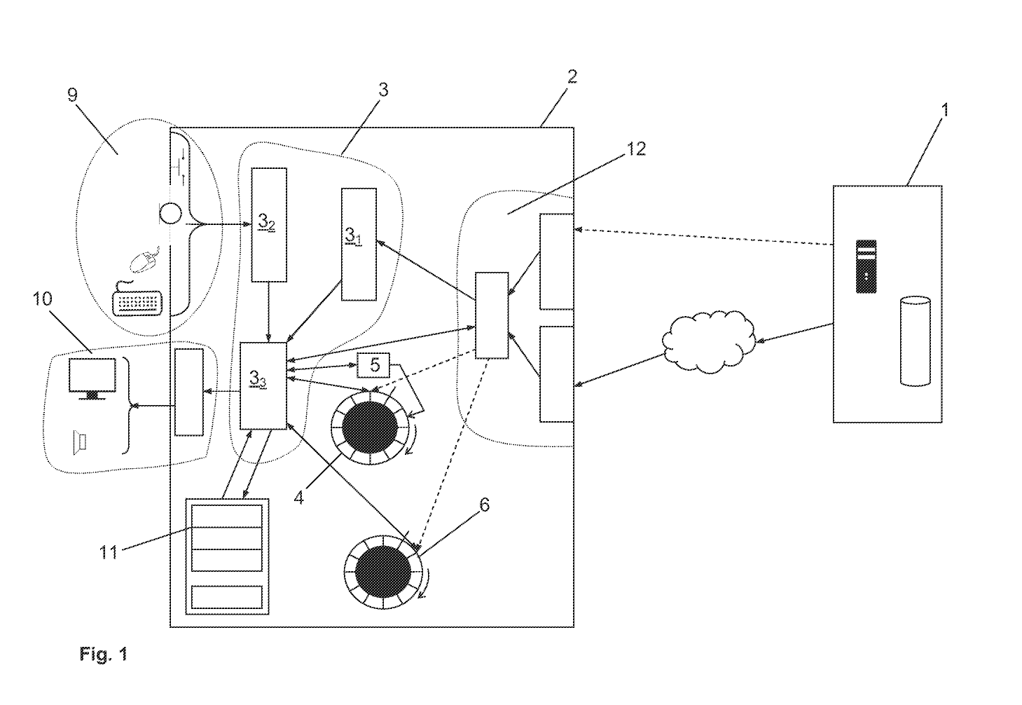

FIG. 1 shows by way of example a possible embodiment of the system according to the invention in which the schedule of a channel source 1, specifically of a broadcaster which broadcasts or transmits the schedule, is stored locally, in other words in storage media of a terminal arrangement 2 also provided for the playback of broadcast media items. Accordingly, the system includes the aforementioned channel source 1, in the example, of a broadcaster which broadcasts the schedule in a conventional manner, that is to say for example terrestrially or by satellite, preferably as a digital broadcast signal, and/or via a communication network such as the Internet by streaming, and of the likewise aforementioned terminal arrangement 2. Said arrangement may be a single terminal or a group, arranged at a user's location, of terminals or components for immediate or time-delayed playback of the schedule broadcast by the channel source 1, including media items contained therein. In addition to the component 12 for receiving a media data stream from at least one channel source 1, in addition to the component 10 for acoustic and/or visual playback of media items (loudspeaker, display or screen and the like) and operating elements 9 for operating the terminal arrangement (remote control, keyboard, mouse, touch-sensitive screen or microphone and the like), important elements of this terminal arrangement 2 include the component for storing the schedule received from the channel source 1 for time-delayed playback of media items contained therein and a control device 3 which controls the interaction of all of the aforementioned components. Of course, corresponding interfaces or receiving components for the schedule broadcast by the channel source 1 also belong to the terminal arrangement.

For recording the schedule of one or more channel sources, a first memory is provided in which, for each channel source 1 provided for recording the schedule thereof, a memory region 4 organised as a FIFO memory is reserved. Because it is formed as a FIFO memory, this reserved memory region 4 in effect forms a ring buffer of a defined size, in which the schedule broadcast by the respective channel source 1 is recorded irrespective of whether the channel source 1 in question is currently selected for playing back the current schedule thereof via the terminal arrangement 2. The schedule of the channel source 1 in question is recorded at least in the switched-on state or in standby operation of the terminal arrangement 2, without further operating actions by the user or operating actions provided specially for this purpose being required.

In this connection, it should again be noted that in the switched-on state the one channel source (shown by way of example) or one of a plurality of possible channel sources need not necessarily be selected for playback of the currently broadcast schedule, but instead the terminal arrangement 2 could also have been merely switched on by a user, so as to play content or items already recorded previously. Irrespective thereof, however, the recording of the schedule of the one channel source or if applicable the recording of the schedule of a plurality of channel sources 1 for which this is provided takes place in the background. In the latter case, in which for example a recording of the schedule of ten or more channel sources 1 (not shown here) selected as favourites is possible via the terminal arrangement 2, said terminal arrangement comprises a corresponding number of memory regions 4 reserved therefor, each in the form of a FIFO memory. However, this does not exclude the possibility that only one storage medium is physically present, on which a plurality of memory regions 4 of this type are reserved for the schedule recording via a corresponding logical management. The individual broadcasters or channel sources 1 are differentiated by a broadcaster identifier, which is transmitted thereby together with the schedule or the items and by which the reserved memory region 4 to be used in each case for the recording is determined.

A further component of the terminal arrangement 2, belonging to the control device 3 of the terminal or implemented by said control device and software processed thereby, includes a component 3₁ for evaluating signals of a channel source 1 of which the schedule is being recorded in a memory region 4 reserved therefor, according to features which indicate the start of an item. Preferably, these features are additional data, which are broadcast by the respective channel source 1 together with the schedule to be recorded and which contain details concerning the temporal start of individual items. The control device further includes a component 3₂ for input processing and an information management component 3₃ which processes in particular the program application (or app).

For a schedule 1 recorded in the memory region 4 reserved therefor, the respective current address of the reserved memory 4 written together with the media data stream of the schedule is noted as the write address in a pointer memory 5 also provided as a component of the terminal arrangement 2. If, during the recording of the schedule of a, or, in the example, of the one channel source 1, a start of an item is detected on the basis of the aforementioned features, the current write address currently noted in the pointer memory 5 is copied into a separate address memory 6 provided for this purpose. In the example shown, this address memory 6 is formed for receiving a plurality of addresses, each indicating a start of an item within the schedule recorded in the reserved memory region 4, and is also organised as a FIFO memory. In a further pointer memory, also held in an operating memory (not shown) or in a register of the terminal arrangement (also not shown), an address is held which in each case points to the address in the address memory 6, organised as a FIFO memory, according to which the address of a start of an item was most recently noted in the reserved memory region 4.

If a user of the terminal arrangement 2 now selects a channel source 1, from a favourites memory or from another schedule, to play back the currently broadcast schedule thereof, and addresses a playback request to the terminal arrangement 2 subsequently or at a later point in time via a further operating process, it is possible for him, irrespective of the point in time at which the channel source 1 is selected, to play back an already running media item of interest to him in a time-delayed manner together with the start thereof, or at least from the earliest point in time available in the reserved memory region 4. In this case, the output (and only the output) of the currently broadcast schedule via the output component 10 is interrupted, and instead the media data stream stored for the selected item in the memory region 4 is called from the memory region 4 and outputted via the output component 10. In connection with this, in the embodiment shown it is additionally possible for the user, via a corresponding operating action, to store a played-back item again in parallel in a separate memory region 11 for the purpose of further later playback.

Furthermore, however, items which are played back from the ring buffer or from the reserved memory region 4 as a result of corresponding operating actions of the user may also be marked in this reserved memory region 4 via additional information, for example by placing a characteristic bit in metadata of the item. This can be used, in combination with item identifiers contained in metadata, for the purpose whereby, if the same item (for example a piece of music), having the same item identifier, is broadcast again and the playback of this item is requested again from the memory region 4 reserved for recording the channel source 1 which broadcasts it, the item which may already be present in the ring buffer or in the reserved memory region 4 for another channel source 1 is automatically transferred to the aforementioned separate memory region 11 for parallel storage if that item is marked by said additional information as already having been requested once by the user.

The operating processes required in each case for selecting the channel source 1 and triggering a playback request are carried out by the user via the input component 9 provided for this purpose and are interpreted by the control device 3 of the terminal arrangement 2, which subsequently also causes the respectively desired function to be carried out. During the time-delayed playback of a scheduled item (media item) which takes place after a playback request of this type, the recording of the schedule of the corresponding channel source 1 is continued.

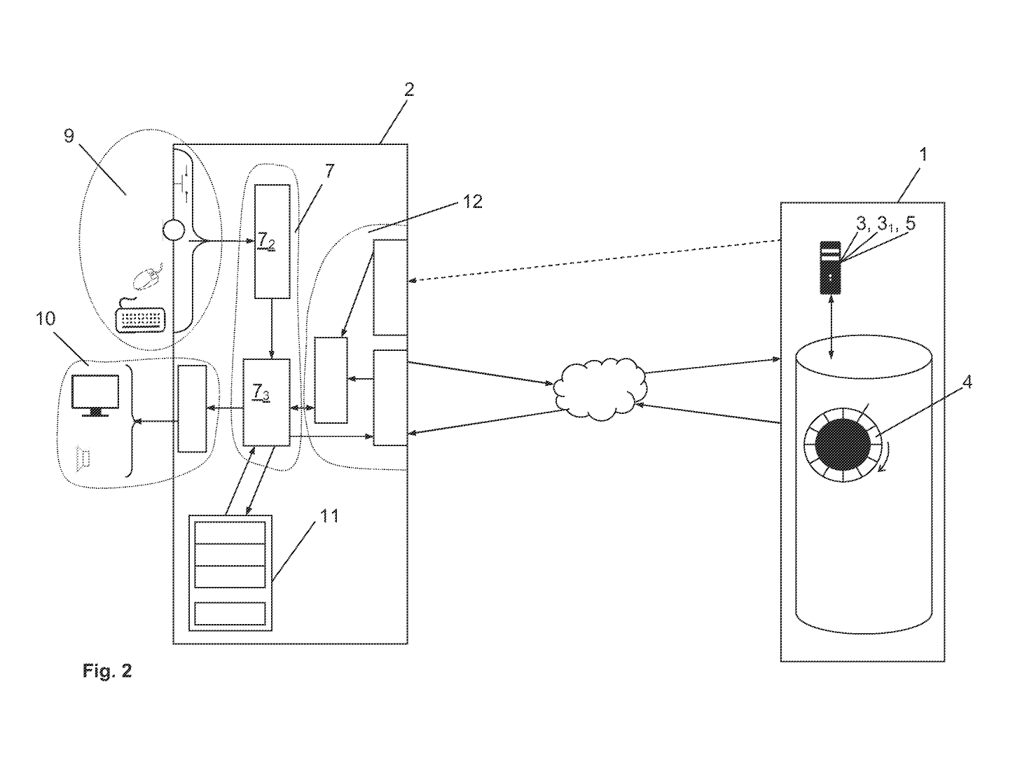

In a deviation from the above-described embodiment of the proposed system, in the embodiment shown in FIG. 2 the schedule of the at least one channel source 1 is recorded centrally, that is to say at the channel source 1 broadcasting the schedule or the broadcaster itself. Accordingly, in this embodiment, the memory required for this purpose comprising the memory region 4 reserved for the recording is a component of devices formed at the broadcaster end or at the channel source 1. This also applies to the component 3₁ for detecting a start of an item, as part of the control device 3 which processes a corresponding piece of software, which control device is for example in the form of a server belonging to the devices at the broadcaster end. In the example shown, also the pointer memory 5 is implemented in this server, which optionally further serves to broadcast scheduled content over the network by streaming. By way of example, an embodiment is shown in which the address memory is omitted and features for indicating a start of an item are recorded together with the data stream of the recorded schedule. A feature of this type which indicates a start of an item is generated for example by component 3₁ arranged in the server, which evaluates the schedule to be recorded for the presence of a start of an item. It is not necessary for a broadcaster identifier to be transmitted for the purpose of subsequently selecting an item played back in a time-delayed manner, since in this embodiment the broadcaster or channel source 1 is, of course, defined directly.

At least if the system merely makes time-delayed playback of a running item possible, it is additionally possible to dispense with the transmission of an item identifier by the channel source 1 and the recording thereof in association with the feature for the start of an item, since the item to be played back in a time-delayed manner is defined by the point in time of the input of a playback request from a or the terminal arrangement 2.

Of course, in this case too, the terminal arrangement 2 belonging to the system shown by way of example has a component 10 for acoustic and/or visual output of media items, which may take place in real time, in other words by outputting the schedule currently being broadcast by the channel source, or in a time-delayed manner. Furthermore, operating elements 9 of the terminal arrangement 2, component 12, that is to say receiving components for receiving the running schedule broadcast by the or a channel source 1 or an item transmitted in a manner time-delayed therefrom, are components of the terminal arrangement 2. In this context, the terminal arrangement 2 has a receiving component 12 for receiving a schedule transmitted in a conventional manner (terrestrial or satellite) as well as those for receiving a running schedule transmitted over a communication network or media items transmitted over a network of this type and played back in a time-delayed manner. The interaction of the aforementioned appliances or components of the terminal arrangement 2 is controlled by a control device 7 also belonging thereto, which also comprises the component 7₂ for input processing and the information management component 7₃. As a result of these, also in the case of a corresponding operating action by the user a playback request for time-delayed playback of an item recorded at the broadcaster end is also generated and transmitted to the corresponding broadcaster or the corresponding channel source 1, in other words to the control device 3 arranged there. The terminal arrangement 2, shown in FIG. 2 as part of the system shown, additionally further has a separate memory region 11 comprising a data buffer, in which items of the running schedule or items transmitted in a time-delayed manner by the channel source can be archived. Also the functions required in this regard are controlled by the control device 7 of the terminal arrangement 2, optionally in interaction with the control device 3.

For the time-delayed playback of an already running item of the channel source, the user actuates a corresponding operating element 9. Thereupon, the control device 7 of the terminal arrangement 2 generates a playback request and sends this to the (currently selected) current channel source 1 or the broadcaster in an agreed format as a download or streaming request, for example over the Internet, by corresponding activation of a transmission component. If this channel source 1 is a broadcaster which transmits its channel in the form of a live stream, a corresponding Internet address for the channel source 1 is noted in a memory (not shown) of the terminal arrangement 2. If the running item is broadcast by a channel source 1 of which the schedule is received by the terminal arrangement 2 via a conventional receiving path—for example terrestrially—an access address may be contained in digital additional information (RDS, videotext and the like) which is broadcast by the channel source 1 in parallel with the schedule. In this case, different access addresses may also be sent depending on the item, and are subsequently decoded and evaluated by the receiver. It is also possible for the user of the terminal arrangement 2 to input addresses assigned to the channel sources 1 (for example the favourite broadcasters) into the memory manually using the software implemented on the terminal, or to download them over the Internet. In the latter case, automatic loading is possible via the set or sent broadcaster names and URIs (uniform resource identifiers) or IP addresses generated therefrom.

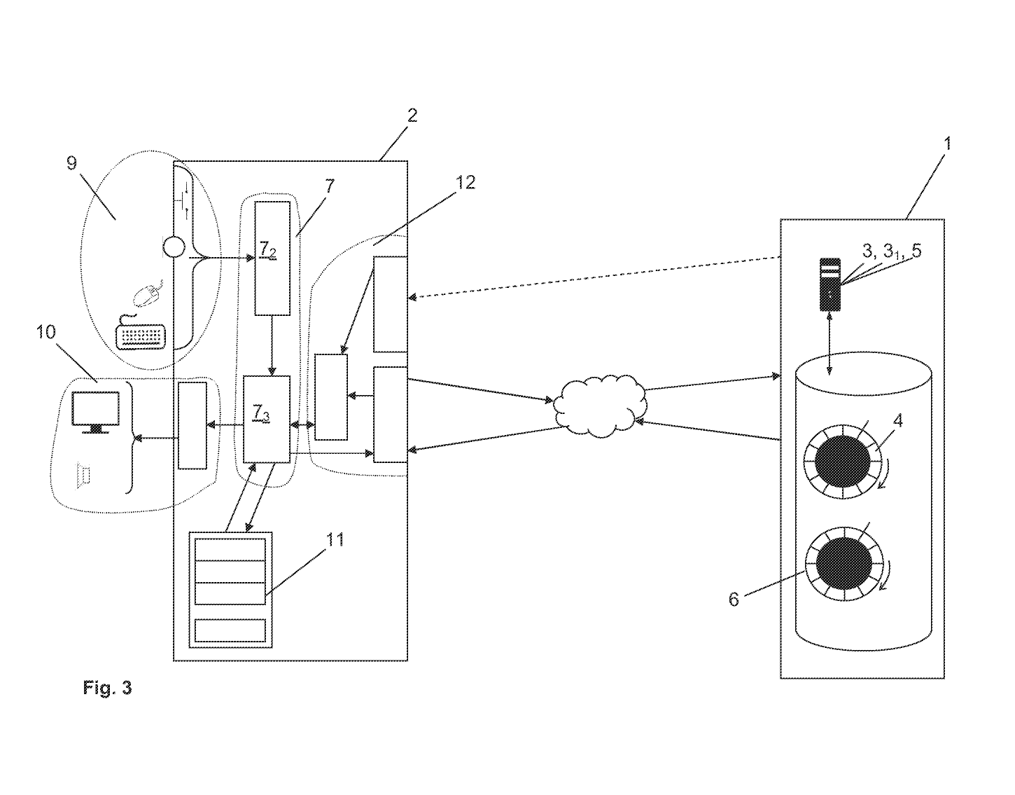

FIG. 3 shows an embodiment comparable with FIG. 2 of the system according to the invention, in which the recording of the running schedule and the time-delayed provision of media items are also provided by devices arranged at the broadcaster end, in other words at the channel source 1. In a deviation from the embodiment shown in FIG. 2, the shown in FIG. 3 operates using an address memory 6, in which a plurality can be stored, in each case to an item start, in the reserved memory region 4 organised as a circular buffer. The corresponding address memory 6 is also organised as a FIFO memory or ring buffer. Otherwise, the embodiment of the system shown in FIG. 3 corresponds to the system according to FIG. 2.

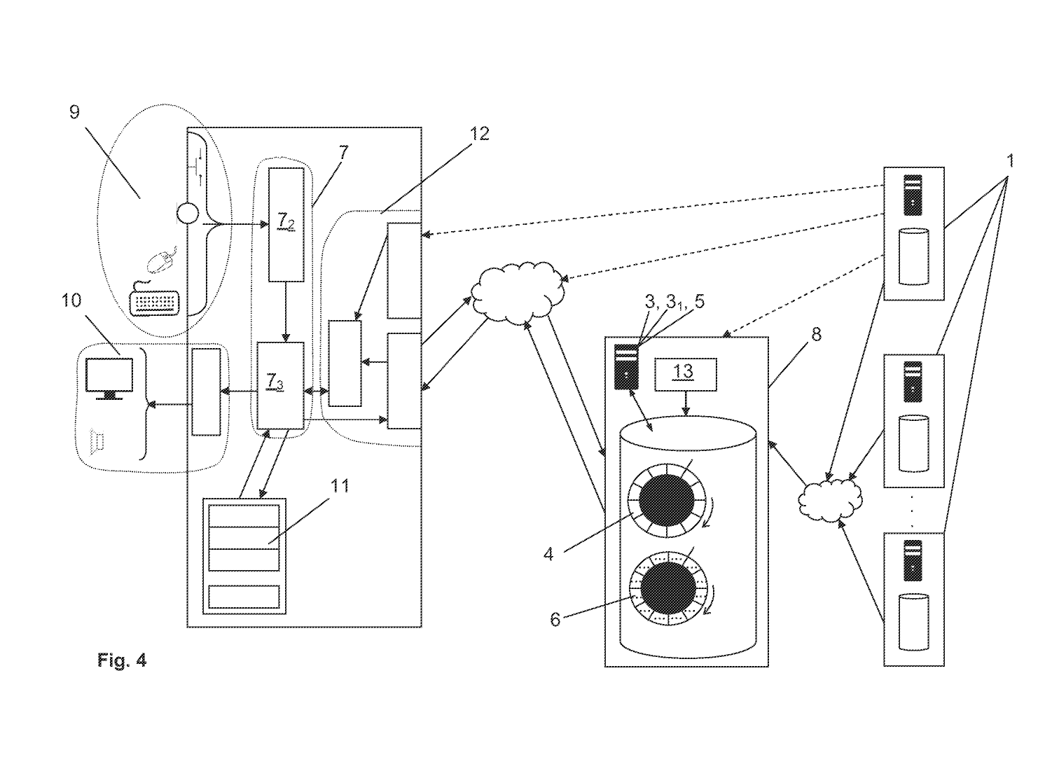

The further embodiment shown in FIG. 4 of the system according to the invention is in turn comparable with the system shown in FIG. 3. This embodiment basically differs from that of FIG. 3 in that the storage media, that is to say the memory comprising the reserved memory region 4 organised as a FIFO memory for the schedule recording and an address memory 6 for storing addresses for starts of items of the schedule indicated in the aforementioned memory region 4, are accommodated in devices 8 of a service provider which are arranged between the terminal arrangement 2 and the channel source 1 in logical terms. In this context, as is shown in the drawing, there is the option of the schedules of a plurality of schedule providers or channel sources 1 being recorded permanently in the storage media of the devices 8 in question of this service provider. To distinguish the individually recorded schedules, in each case a broadcaster identifier is also sent from the channel sources 1 broadcasting said schedules to the service provider, and is processed thereby for the logical control of the recording and playback processes. Since the service provider itself determines the broadcasters or channel sources 1 of which the schedule is recorded, it can also issue corresponding broadcaster identifiers itself and have these inserted into the corresponding media data stream by its technical devices 8 configured for this purpose. Components 13 for receiving the media data from the channel sources 1 are also components of the devices 8.

The use of at least one reserved memory region 4, organised as a FIFO memory or ring buffer, for recording the schedule of at least one channel source 1 is common to all of the embodiments shown in FIG. 1 to 4.

If, as in the embodiments according to FIG. 1, FIG. 3 and FIG. 4, each system is configured for recording not only a respective running item of the channel source 1 in question but for recording a plurality of items, for which the address of the start thereof is noted within the reserved memory region 4 used for the recording in an address memory 6, this address memory 6 is also organised as a FIFO memory or ring buffer.

In general, ring buffers are set up to write information continuously to a limited memory region which is subsequently asynchronously read out and processed. For this purpose, newly arriving data are written to the memory region pointed to by an address pointer (in-pointer) held in a pointer memory, that is to say in the general operating memory or a register. An address pointer (out-pointer) which is optionally further held in this memory points to the start of the data which have not yet been read out and released from the ring buffer. A buffer overflow is reached when the in-pointer fetches the out-pointer. An out-pointer is conventionally used to read data back out from a memory in the order of the previous arrival thereof and to supply them to the further processing operation. However, in the context of the invention, the out-pointer has a different function. In this case, the out-pointer is merely a simple read pointer, which is set to the start of an item or the earliest point in time of the item available in the memory when the item is called for time-delayed playback thereof. This pointer is required for reading out, but without checking for any buffer overflow in the process.

In an embodiment, the newly arriving data of the media data stream of the recorded schedule are written to the memory region pointed to by an address pointer held in a pointer memory, namely an in-pointer, but no out-pointer within the meaning described at the beginning of the preceding paragraph is provided. This means that it is not monitored whether, during the continuing recording of data of the media data stream, particular regions, which may not yet have been read out, of the ring buffer are overwritten. If the ring buffer is of a defined but sufficient size, making it possible for example to record several hours of media data (for example video or music), it can generally be assumed that a plurality of items can be stored. All items which are recorded as part of the received schedule, and for which playback (time-delayed playback) in the disclosed form is to be made possible, are transferred, into the memory region or ring buffer reserved for the recording, almost in real time, in other words in parallel with the arrival thereof in the components provided for the recording thereof and for controlling this recording.

To make it possible to detect a start of an item, item identifiers, which change for each new item, may be contained in the additional data of the broadcasters (channel sources). If the control device controlling the access to the storage medium for recording the schedule now establishes a change in the item identifier, the write address, which is current at this point in time and is noted in the pointer memory, of the recording process taking place in the reserved memory region or—in accordance with the wording above—of the in-pointer (or a value functionally derived therefrom for example by adding/subtracting a fixed second value) is entered in the address memory used for noting start addresses of stored items. The value of a further pointer, held in an operating memory of the system and pointing to the address memory comprising the addresses of the starts of the items, or a further in-pointer is placed before the entry most recently made in the address memory. Within the address memory, this further pointer/in-pointer accordingly always points to the address stored most recently therein for a start of an item and referring to the memory region reserved for the recording. This is the start address of the currently running item in the recorded schedule.

In a deviation from these last statements, the embodiment according to FIG. 2, as stated previously, does not operate using a special address memory 6 for storing the start addresses of items within the reserved memory region 4 comprising the recorded schedule. A separate address memory 6, possibly also in the form of a ring buffer, can thus be dispensed with. Instead, a start identifier (and optionally also an end identifier) is entered continuously directly into the memory region 4 formed as a ring buffer and reserved for recording the schedule.

If no item identifiers are sent by the broadcaster, a change of item can be detected on the basis of in received EPG (electronic programme guide) or other additional information from the broadcasters or channel sources 1, which contain times for the start (and possibly the end) of items, such as schedule tables. Regions containing details relating to the respective current item may also be defined in the EPG or in other additional information of the broadcaster. A change in these details may likewise be interpreted as a change in item by the control device 3 controlling the recording process. Furthermore, in the aforementioned control device 3, pattern detection methods may be used, which detect a change in item by interpreting for example changes of scene, changes from music to speech or vice versa in the incoming audio data as a change in item.

In this case, the items recorded as part of the schedule of a channel source 1 are accordingly separated from one another within the reserved memory region 4 by start identifiers (end identifiers) which are generated by a control device 3 or the component 3₁ thereof, and which include data not present in the media data stream and are written to the memory portion indicated by the in-pointer (current write address within the reserved memory region) at the start (end) of an item. The start identifier (or end identifier) can be supplemented with a specific item identifier which is optionally contained in the data received from the broadcaster (from the channel source 1).

If the control device 3 managing the access to the memory receives a playback request for the running item as a result of a corresponding operating action, the data, stored in the reserved memory region 4, of the running item are sent to an output interface, in other words to a display and/or loudspeaker as a component of the component 10 for output, from the start of the recording. In the case where start identifiers (end identifiers) recorded together with the media data stream in the reserved memory region 4 are used, the start of the running item may be found via a corresponding search for the start identifier of the item backwards from the memory address indicated by the current write address or the in-pointer, and the item may be output from there. As stated above, the recording of the schedule of the corresponding channel source 1/of the broadcaster is continued in the background in this case.

If an item further back is requested, a search is carried out in the address memory or, (in the case of FIG. 2) depending on the number of further back items, for further back start identifiers in the reserved memory region 4, on the basis of the sent item identifier or the number of further back items detected in the receiver (for example “0” for the running item, “1” for the previous item, etc.), using a search pointer which is to be decremented or also incremented (depending on the organisation of the address memory 6 organised as a ring buffer). If the changing search pointer reaches the value of the in-pointer, in other words the current write address, this may be referred to as an overflow. In this case, an error code may optionally be generated, or the item actually selected by said search pointer is optionally played back starting in the middle of the item thus detected. It can also be established by the software that the search pointer is changed back to the opposite direction again until the next non-overwritten start identifier or the start address of the next item in the address memory 6 is found. The use of a search method for start identifiers within the memory region 4 reserved for the schedule recording places a heavy load on the resources of the broadcaster/the service provider, in particular for a network-based configuration of the system (the recording memory together with the memory region 4 reserved therefor is formed in devices of the channel source 1/broadcaster or in devices 8 of a service provider) and for a relatively large number of simultaneous playback requests from different terminal arrangements 2. Therefore, a method variant operating using two ring buffers (reserved memory region 4 organised as a FIFO memory for the schedule recording and address memory 6 also organised as a FIFO memory) is preferred in these cases in particular.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for recording of media items broadcast from at least one channel source and for time-delayed playback of a media item recorded in a memory region reserved for time-delayed playback and received by a terminal arrangement configured for time-delayed playback, the method comprising:
recording a schedule broadcast by the at least one channel source as a media data stream, irrespective of whether the at least one channel source is currently selected for playback of the schedule broadcast thereby and independently of further operating actions by a user of the terminal arrangement, wherein the recording comprises: storing in the memory region reserved for time-delayed playback, wherein the memory is organized as a first-in first-out (FIFO) memory, permanently or starting at the point in time at which the terminal arrangement is switched on; and
playing back a media item already running at the point in time at which the at least one channel source is selected, irrespective of the point in time of the selection, from the start of the item, or from an earliest point in time available in the reserved memory region.

2: The method according to claim 1, wherein the schedules of a plurality of channel sources are recorded in parallel, irrespective of whether a channel source is currently selected for playback of the schedule broadcast thereby.

3: The method according to claim 2, wherein the schedule of each of the channel sources to be recorded is recorded in a separate memory region reserved for the respective channel source.

4: The method according to claim 1, wherein the schedule of the at least one channel source is recorded in a memory region formed locally as a component of the terminal arrangement of the user.

5: The method according to claim 1, wherein the schedule of the at least one channel source is recorded in a memory region which is formed in devices of a service provider or in devices belonging to the channel source, which are accessed by the terminal arrangement over a network for the playback of a recorded item.

6: The method according to claim 14, wherein, to provide the item broadcast by the at least one channel source for a playback irrespective of the point in time at which the channel source is selected,
a) the address, currently being written with the media data stream of the recorded schedule of the channel source, of the reserved memory region is held in a pointer memory as the current write address,
b) signals of the channel source, of which the schedule is being recorded according to a), are evaluated according to features which identify the start of an item,
c) for an item start identified according to b), the current write address, held in the pointer memory, of the schedule recording is copied to an address memory, an address noted therein at a start of the item being removed, however, from the address memory again if the current write address of the continued recording process matches this address again,
d) after an operating action, provided for this purpose, of the terminal device is carried out, an item, of the reserved memory region, which is being broadcast by the channel source selected at this point in time, is played back from the address noted in the address memory for the start of the item or, in the case where an address of this type is not noted in the address memory, from the address which follows the current write address noted in the pointer memory and is being written during the current recording process, the recording process being continued.

7: The method according to claim 6, wherein one or more addresses, each referring to the start of an item within the schedule being recorded in the reserved memory region, are noted in the address memory, in this case also formed as a FIFO memory, an operating memory holding a pointer which points to the address of the address memory at which the address, most recently noted for a start of an item, of the memory reserved for the schedule recording is stored.

8: The method according to claim 1, wherein, to provide the item broadcast by the at least one channel source for a playback irrespective of the point in time at which the channel source is selected
a) the address, currently being written with the media data stream of the recorded schedule of the channel source, of the reserved memory region is held in a pointer memory as the current write address,
b) signals of the channel source of which the schedule is being recorded according to a) are evaluated according to features which identify the start of an item,
c) for an item start identified according to b), an identifier for a start of an item is stored at the address which follows the current write address noted in the pointer memory of the reserved memory,
d) after an operating action, provided for this purpose, of the terminal device is carried out, an item, which is being broadcast by the channel source selected at this point in time, is played back from the memory address following the memory address comprising the identifier most recently stored for a start of an item or, in the case where an identifier of this type is not stored in the reserved memory region, from the address, which follows the current write address noted in the pointer memory and is being written, together with the schedule being recorded, during the current recording process, of the reserved memory region, the recording process being continued.

9: The method according to claim 6, wherein signals evaluated for the presence of features indicating a start of an item are data comprising additional information, which are broadcast by the at least one channel source of which the schedule is being recorded in the reserved memory region.

10: The method according to claim 1, wherein the file format of the media data stream broadcast by the at least one channel source is converted, during the recording of the schedule of the channel source in question, into a file format requiring less storage space.

11: A system for recording and time-delayed playback of media items, comprising:
at least one channel source for broadcasting a schedule comprising media items in the form of a media data stream;
storage media for recording the schedule broadcast by the at least one channel source;
a terminal arrangement, which comprises a receiver for receiving the media data stream broadcast by the at least one channel source and a component for immediate or time-delayed acoustic and/or visual playback of media items contained in this media data stream;
a control device for detecting the start of a media item, for evaluating features indicating the start of an item within the recorded schedule, and, during the schedule recording and the time-delayed playback of recorded items, for controlling access to the storage media;
wherein the storage media comprise:
a) a reserved storage region, organized as a first-in first-out (FIFO) memory, for a recording, which is independent of operating actions by a user of the terminal device and irrespective of the channel source currently selected for schedule playback, at least in the switched-on state, of the schedule broadcast by the at least one channel source,
b) a pointer memory for storing, as the current write address, the address, currently being written together with the media data stream, of the storage region reserved according to a), and
c) an address memory for storing at least one memory address of the storage region reserved for the schedule recording, at which a media item starts within the schedule recorded in the storage region.

12: The system according to claim 11, wherein the storage media and the control device are formed as components of devices of a broadcaster acting as a channel source;
wherein the terminal arrangement further comprises: a further control device for interpreting operating actions by a user of the terminal arrangement and activating the terminal arrangement to carry out the functions called by the operating action, and for interacting with the control device over a network for the time-delayed playback of a recorded item.

13: The system according to claim 11, wherein the storage media and the control device are formed as components of devices of a service provider;
wherein the service provider is configured to record schedules of a plurality of channel sources and provide media items contained therein for time-delayed playback; and
wherein the terminal arrangement further comprises: a further control device for interpreting operating actions by a user of the terminal arrangement and activating the terminal arrangement to carry out the functions called by the operating action, and for interacting with the control device over a network for the time-delayed playback of a recorded item.

14: A terminal arrangement, comprising:
a receiver;
storage media for recording a media data stream broadcast by at least one schedule source;
a component for immediate or time-delayed acoustic and/or visual playback of media items contained in this media data stream;
a control device for detecting the start of a media item, for evaluating features indicating the start of an item within the recorded schedule, and, during the schedule recording and the time-delayed playback of recorded items, for controlling access to the storage media;
wherein the storage media comprise:
a) a reserved storage region, organised as a first-in first-out (FIFO) memory, for a recording, which is independent of operating actions by a user of the terminal device and irrespective of the channel source currently selected for schedule playback, at least in the switched-on state, of the schedule broadcast by the at least one channel source,
b) a pointer memory for storing, as the current write address, the address, currently being written with the media data stream, of the storage region reserved according to a), and
c) an address memory for storing at least one memory address of the storage region reserved for the schedule recording, at which a media item starts within the schedule recorded in the storage region.
